(19) United States
(12) Patent Application Publication
(10) Pub. No.: US 2026/0311399 A1
(43) Pub. Date: Oct. 8, 2026

(54) Generative Custom Stickers

(71) Applicant: Google LLC, Mountain View, CA (US)

(72) Inventors: Jiawei Chen, Mountain View, CA (US); Jiabao Guo, Bellevue, WA (US); Rongjing Xiang, Sunnyvale, CA (US); Yun Lin, San Jose, CA (US); Yang Lu, San Jose, CA (US); Lin Guo, Santa Clara, CA (US); Xu Liu, San Jose, CA (US); Yang Ren, Beijing (CN); Liangyi Ou, Cupertino, CA (US); Dun Liu, Mountain View, CA (US)

(73) Assignee: Google LLC, Mountain View, CA (US)

(21) Appl. No.: 19/481,132

(22) PCT Filed: Jun. 26, 2023
(86) PCT No.: PCT/US2023/026241

§ 371 Date: Nov. 3, 2025

Related U.S. Application Data
(60) Provisional application No. 63/501,017, filed on May 9, 2023.

(51) Int. Cl. G06T 11/60; G06F 40/109; G06F 40/30

(52) U.S. Cl. CPC G06T 11/60; G06F 40/109; G06F 40/30; G06T 2200/24

(57) ABSTRACT

A method comprising obtaining, by a computing device, an image generation prompt that includes a description of an image to be generated. The method further includes providing, by the computing device, the image generation prompt to a machine learning model. The method further includes obtaining, by the computing device, the image from the machine learning model. The method further includes outputting, by the computing device, a graphical user interface that includes the image.

### BACKGROUND

Users may communicate with each other via one or more computing devices. In some cases, the communications (e.g., an email, a text message, a meeting request, etc.) may include text, images, etc. A computing device may enable a user of a computing device to respond to an incoming communication by allowing the user to include an image and send the image to other computing devices as a response.

### SUMMARY

Techniques are described by which a computing device may use a machine learning model to generate or modify visual expressions that users may share with each other. For example, a computing device associated with a user may apply a machine learning model to generate a modified image based on input by the user. The input may include an image (e.g., a picture, a drawing, an emoticon, etc.), a text prompt describing a desired visual expression (including a modification to an existing image), gesture input for drawing a visual expression, text to change to a different stylized typography, etc. In general, the modified image may adhere to the creative vision of the user (e.g., incorporate desired visual elements of typographic styles) while retaining comprehensible text (e.g., generated text that is not garbled) and ensuring that the resulting image is sensible. In this way, the techniques of this disclosure may provide various advantages, such as enabling a user to seamlessly combine emoticons and create images with stylized text using a broad range of typographical styles.

In some examples, a method includes obtaining, by a computing device, an image generation prompt that includes a description of an image to be generated. The method further includes providing, by the computing device, the image generation prompt to a machine learning model. The method further includes obtaining, by the computing device, the image from the machine learning model. The method further includes outputting, by the computing device, a graphical user interface that includes the image.

In some examples, a computing device has a memory, one or more programmable processors in communication with the memory, and is configured to obtain an image generation prompt that includes a description of an image to be generated. The one or more programmable processors are further configured to provide the image generation prompt to a machine learning model. The one or more programmable processors are further configured to obtain the image from the machine learning model. The one or more programmable processors are further configured to output a graphical user interface that includes the image.

In some examples, a computer-readable storage device is encoded with instructions that, when executed by one or more processors, cause the one or more processors to obtain an image generation prompt that includes a description of an image to be generated. The instructions are further configured to cause the one or more processors to provide the image generation prompt to a machine learning model. The instructions are further configured to cause the one or more processors to obtain the image from the machine learning model. The instructions are further configured to cause the one or more processors to output a graphical user interface that includes the image.

The details of one or more examples are set forth in the accompanying drawings and the description below. Other features, objects, and advantages will be apparent from the description and drawings, and from the claims.

### BRIEF DESCRIPTION OF DRAWINGS

FIGS. 1A-1B are conceptual diagrams illustrating example computing environments and graphical user interfaces for providing images generated in response to a user prompt in accordance with one or more techniques of this disclosure.

FIG. 2 is a block diagram illustrating an example of a computing device in accordance with one or more techniques of this disclosure.

FIG. 3 is a block diagram illustrating an example of a cloud computing platform in accordance with one or more techniques of this disclosure.

FIG. 4 is a block diagram illustrating an example operation of a machine learning model in accordance with techniques of this disclosure.

FIGS. 5A-5C are conceptual diagrams illustrating graphical user interfaces for generating images in accordance with one or more techniques of this disclosure.

FIG. 6 is a flow diagram illustrating an example operation for generating images in accordance with one or more techniques of this disclosure.

FIG. 7 is a conceptual diagram illustrating an example computing environment and graphical user interfaces for providing images generated in response to a user prompt in accordance with one or more techniques of this disclosure.

### DETAILED DESCRIPTION

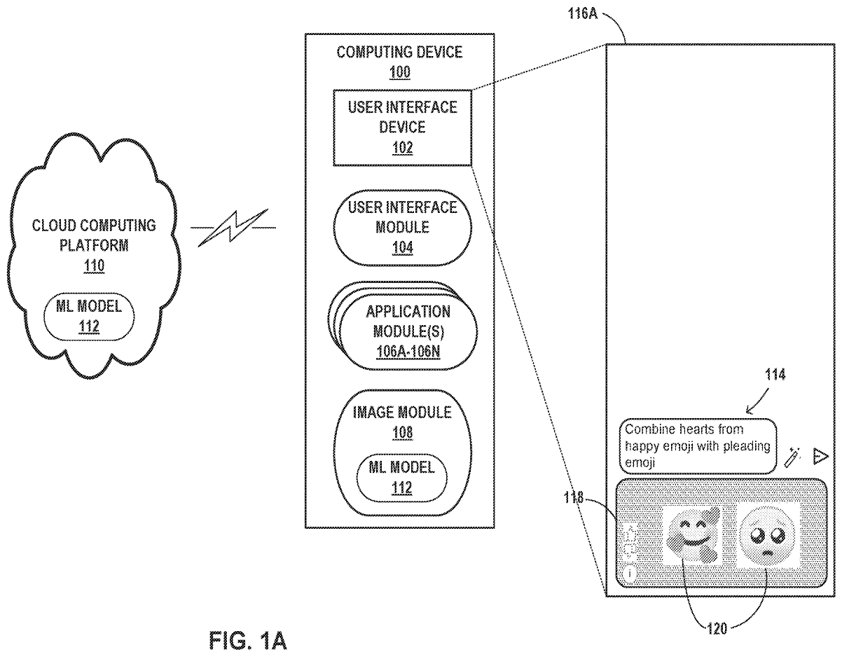

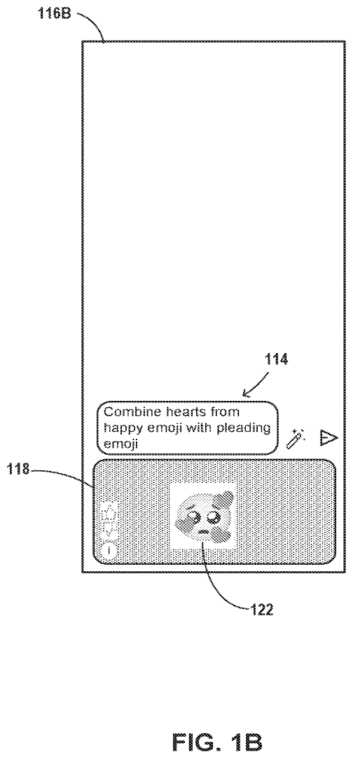

FIG. 1A is a conceptual diagram illustrating an example computing system and graphical user interface 116A (“GUI 116”) for generating images according to user prompts, in accordance with one or more techniques of this disclosure. As shown in the example of FIG. 1, the computing system includes computing device 100 and cloud computing platform 110. Examples of computing device 100 may include, but are not limited to, portable, mobile, or other devices, such as mobile phones (including smartphones), wearable computing devices (e.g., smart watches, smart glasses, etc.) laptop computers, desktop computers, tablet computers, smart television platforms, server computers, mainframes, infotainment systems (e.g., vehicle head units), etc. In some examples, computing device 100 may represent a cloud computing system that provides one or more services via a network. That is, in some examples, computing device 100 may be a distributed computing system. Examples of cloud computing platform 110 may include, but are not limited to server computers, mainframes, cloud compute nodes, distributed computing environments, and virtualized computing environments.

As shown in the example of FIG. 1A, computing device 100 includes one or more user interface (UI) devices (“UI device 102”). UI device 102 of computing device 100 may be configured to function as an input device and/or an output device for computing device 100. UI device 102 may be implemented using various technologies. For instance, UI device 102 may be configured to receive input from a user through tactile, audio, and/or video feedback. Examples of input devices include a presence-sensitive display, a presence-sensitive or touch-sensitive input device, a mouse, a keyboard, a voice responsive system, video camera, microphone or any other type of device for detecting a command from a user. In some examples, a presence-sensitive display includes a touch-sensitive or presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive technology. That is, UI device 102 of computing device 100 may include a presence-sensitive device that may receive tactile input from a user of computing device 100. UI device 102 may receive indications of the tactile input by detecting one or more gestures from the user (e.g., when the user touches or points to one or more locations of UI device 102 with a finger or a stylus pen).

UI device 102 may additionally or alternatively be configured to function as an output device by providing output to a user using tactile, audio, or video stimuli. Examples of output devices include a sound card, a video graphics adapter card, or any of one or more display devices, such as a liquid crystal display (LCD), dot matrix display, light emitting diode (LED) display, miniLED, microLED, organic light-emitting diode (OLED) display, e-ink, or similar monochrome or color display capable of outputting visible information to a user of computing device 100. Additional examples of an output device include a speaker, a haptic device, or other device that can generate intelligible output to a user. For instance, UI device 102 may present output to a user of computing device 100 as a graphical user interface that may be associated with functionality provided by computing device 100. In this way, UI device 102 may present various user interfaces of applications executing at or accessible by computing device 100 (e.g., an electronic message application, an Internet browser application, etc.). A user of computing device 100 may interact with a respective user interface of an application to cause computing device 100 to perform operations relating to a function.

In some examples, UI device 102 of computing device 100 may detect two-dimensional and/or three-dimensional gestures as input from a user of computing device 100. For instance, a sensor of UI device 102 may detect the user's movement (e.g., moving a hand, an arm, a pen, a stylus, etc.) within a threshold distance of the sensor of UI device 102. UI device 102 may determine a two- or three-dimensional vector representation of the movement and correlate the vector representation to a gesture input (e.g., a hand-wave, a pinch, a clap, a pen stroke, etc.) that has multiple dimensions. In other words, UI device 102 may, in some examples, detect a multidimensional gesture without requiring the user to gesture at or near a screen or surface at which UI device 102 outputs information for display. Instead, UI device 102 may detect a multi-dimensional gesture performed at or near a sensor which may or may not be located near the screen or surface at which UI device 102 outputs information for display.

In the example of FIG. 1A, computing device 100 includes user interface (UI) module 104, application modules 106A-106N (collectively “application modules 106”). Modules 104 and 106 may perform operations described herein using hardware, software, firmware, or a mixture thereof residing in and/or executing at computing device 100. Computing device 100 may execute modules 104 and 106 with one processor or with multiple processors. In some examples, computing device 100 may execute modules 104 and 106 as a virtual machine executing on underlying hardware. In some examples, computing device 100 may include one or more programmable processors in communication with memory and configured to execute one or more instructions associated with the techniques of this disclosure. In some examples, computing device 100 may include a non-transitory computer-readable encoded with instructions that, when executed by one or more processors, cause the one or more processors to execute one or more techniques of this disclosure. Modules 104 and 106 may execute as one or more services of an operating system or computing platform or may execute as one or more executable programs at an application layer of a computing platform.

UI module 104, as shown in the example of FIG. 1A, may be operable by computing device 100 to perform one or more functions, such as receive input and send indications of such input to other components associated with computing device 100, such as application modules 106. UI module 104 may also receive data from components associated with computing device 100 such as application modules 106. Using the data received, UI module 104 may cause other components associated with computing device 100, such as UI device 102, to provide output based on the data. For instance, UI module 104 may receive data from one of application modules 106 to display a GUI.

Application modules 106, as shown in the example of FIG. 1A, may include functionality to perform any variety of operations on computing device 100. For instance, application modules 106 may include a word processor, a text application, a web browser, a multimedia player, a calendar application, an operating system, a distributed computing application, a graphic design application, a video editing application, a web development application, or any other application. One of application modules 106 (e.g., application module 106A) may be a text messaging or Short Message Service (SMS) application. Application module 106A may include functionality to compose outgoing text message communications, receive incoming text message communications, respond to incoming text message communications, and other functions. Application module 106A, in various examples, may provide data to UI module 104 causing UI device 102 to display a GUI.

In some examples, one or more of application modules 106 may be operable to receive incoming communications from other devices (e.g., via the network) such as cloud computing platform 110. For instance, one or more of application modules 106 may receive text messages for an account associated with a user of computing device 100, calendar alerts or meeting requests for a user of computing device 100, or other incoming communications.

In general, communications may include information (e.g., generated in response to input by users of the other devices). Examples of information include text (e.g., any combination of letters, words, numbers, punctuation, etc.), emoji, emoticons, images, video, audio, or any other content that may be included in a communication. In the example of FIG. 1A, application module 106A may receive data regarding generated images from cloud computing platform 110. In addition, in the example of FIG. 1A, application module 106A may receive a message from another user or computing device.

Computing device 100 may communicate with other computing devices via a network. The network may include any public or private communication network, such as a cellular network, Wi-Fi network, satellite communication network, or other type of network for transmitting data between computing devices. In some examples, the network may represent one or more packet switched networks, such as the Internet. Computing device 100 may send and receive data across the network using any suitable communication techniques. For example, computing device 100 may be operatively coupled to the network using respective network links. The network may include network hubs, network switches, network routers, terrestrial and/or satellite cellular networks, etc., that are operatively inter-coupled thereby providing for the exchange of information between computing device 100 and another computing device. In some examples, network links of the network may be Ethernet, ATM or other network connections. Such connections may include wireless and/or wired connections.

In general, a user may use a communication platform provided by application module 106 to electronically communicate with another user via computing device 100. For example, the user may use computing device 100 to send messages to and receive messages from the other user (who may also be using computing device 100 or another computing device). In some examples, the user may want to send a message that includes an image. When doing so, the user may seek to create or modify an image. However, manually creating or modifying an image may require considerable skill and time in order to produce a refined and detailed image. Furthermore, the user may find using UI device 102 to perform precise tasks (e.g., drawing) particularly challenging and inconvenient.

In accordance with the techniques of this disclosure, computing device 100 (and other computing devices) may include an image module 108 that manages the generation of a modified image. Image module 108 may generate a modified image using one or more processors of computing device 100 and/or may request generation of the image by cloud computing platform 110. Image module 108 may communicate with ML model 112 executed by cloud computing platform 110 or ML model 112 executed by computing device 100. Image module 108 may communicate with an ML model that is trained on large amounts of data in order to generate images. In some examples, the user input may include a selection of a two or more emoticons from a library of emoticons for image module 108 to combine according to an image generation prompt entered by a user of computing device 100 (e.g., “combine sad emoji with glasses from the smart emoji”). In other examples, the user input may include a selection of text and an image generation prompt for image module 108 to generate an image of the selected text according to the image generation prompt. The user input may include a request to create one or more emoji style stickers, dynamic text stickers, or personal avatars to represent the emotions and semantics of a user's textual prompt. In this way, the techniques may help manifest the imagination of a user of computing device 100, allowing greater and more effective expression. In turn, the techniques may reduce the number of interactions with computing device 100 and the time to achieve an image satisfying the creative vision of the user.

Images 120 may include one or more selections of an image by a user. For example, images 120 may include the selection of two or more emoticons that a user wishes to combine. Images 120 may include a user selection of elements of the two or more emoticons that the user wishes to combine.

In some examples, GUI 116A may include area 118 for drawing. UI device 102 may receive an input from a user of drawing at least a portion of image 120 within area 118. Additionally, UI module 104 may output, for display by UI device 102, image 120 in area 118, thereby enabling the user to see (e.g., in real-time) the effect of the input on image 120. The user may draw the entirety of images 120 using area 118. Alternatively, the user may select a pre-existing image, causing GUI 116A to include the pre-existing image in area 118. The user may then draw a set of elements in relation to the pre-existing image. The relationship between the set of elements and the pre-existing image may be at least based on the position of the set of elements relative to the position of the pre-existing image.

In some examples, GUI 116A may include text field 114 for a user to provide a text prompt for generating the desired image. In an example, text field 114 may include a user-provided text description of the image that they would like to create in addition to images 120. In another example, text field 114 may include a user prompt such as “combine hearts from happy emoji with pleading emoji” or “word art of ‘good morning’ with coffee in the background”. Computing device 100 may cause the generation of an image using a combination of a user prompt in text field 114 and images 120 in area 118 or may cause generation of an image only using a text prompt within text field 114.

Image module 108 may provide images 120 to cloud computing platform 110, or may utilize images stored in the memory of computing device 100. Cloud computing platform 110 may provide the image to one or more ML models executed by cloud computing platform 110 such as ML model 112. ML model 112 may generate a modified image (e.g., modified image 122 as illustrated in FIG. 1B). Additionally, ML model 112 executed by computing device 100 may generate a modified image. ML model 112 may produce one or more unique images (e.g., different variations), apply an artistic style (e.g., cubism, impressionism, minimalism, contemporary, abstract, baroque, etc.), etc. ML model 112 may generate an emoji kitchen (EK) by combining two or more emoji images that preserve the details of each emoji and/or combine a single emoticon with an add-on element (e.g., tears, sweat, heart, etc.). In addition, ML model 112 may produce an image that is inspired by the style of emoticons, but is in a different format (e.g., a ghost dog emoji rendered in 3 dimensions). Further, ML model 112 may generate customized text stickers based on a user's textual input in accordance with a typography determined from the textual input and background content (e.g., semantics/emotions of the textual input). ML model 112 may generate customized text stickers in accordance with a typography based on a user selection of a background image. In addition, ML model 112 may generate an image according to an image-based condition, where the image-based condition is an image of the text for a message in one or more selected fonts.

In general, image module 108 may provide information (e.g., image 120, messages between users, etc.) to cloud computing platform 110 only if computing device 100 receives permission from the user to send the information. For example, in situations discussed here in which computing device 100 may collect, transmit, or may make use of personal information about a user, the user may be provided with an opportunity to control whether programs or features of computing device 100 can collect user information (e.g., information about a user's communications, a user's social network, a user's social actions or activities, a user's profession, a user's preferences, or a user's current location), or to control whether and/or how computing device 100 may store and share user information.

In addition, certain data may be treated in one or more ways before it is stored, transmitted, or used so that personally identifiable information is removed. For example, a user's identity may be treated so that no personally identifiable information can be determined about the user. Thus, the user may have control over how information is collected about the user and stored, transmitted, and/or used in accordance with techniques of this disclosure.

As shown in FIG. 1B, image module 108 may output, for display by user interface device 102, modified image 122 in area 118 of GUI 116B and, if desirable, perform an action. For example, the user may provide an input that causes ML model 112 to generate variations of modified image 122 without changing the input (e.g., images 120, a text prompt in text field 114) to ML model 112. In another example, the user may edit modified image 122 (e.g., by using area 118 to draw a set of elements), and ML model 112 may use the edited modified image as input to generate another modified image. In yet another example, the user may provide an input that causes computing device 100 to provide modified image 122 to another user (e.g., by sending modified image 122 to another user as a message, by attaching modified image 122 to a message, etc.).

The techniques of this disclosure include one or more advantages. For example, instead of sharing simple, rough sketches, the user may instead use computing device 100 to send refined and detailed images produced by ML model 112. Furthermore, ML model 112 may be able to quickly (e.g., relative to a human) produce the refined and detailed images based on the user drawings or other inputs, in this way expeditiously realizing the creative vision of the user. As a result, the techniques of this disclosure may not only decrease the time to compose messages, but also improve the overall quality of the content of the messages sent by the user.

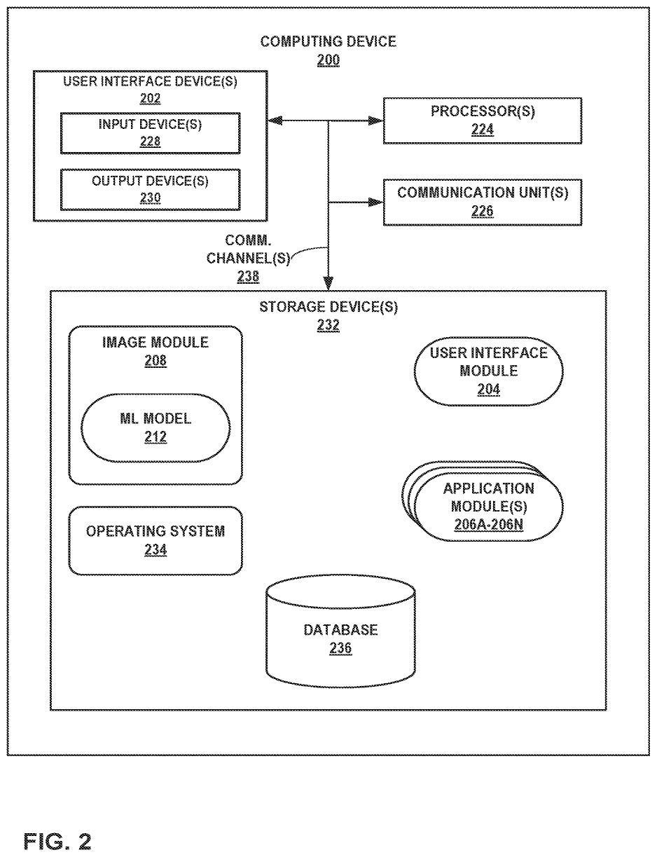

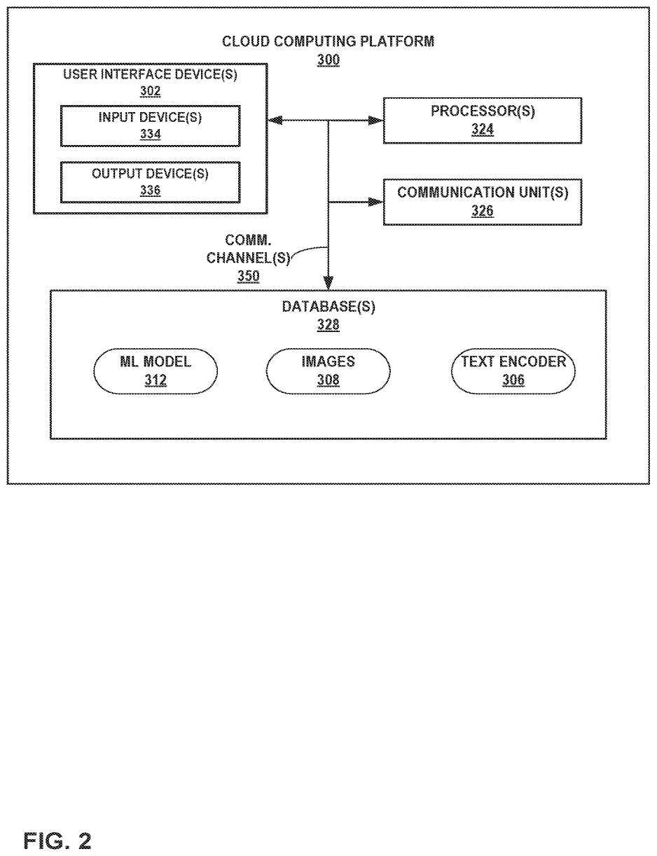

FIG. 2 is a block diagram illustrating a computing device 200. Computing device 200 may be one example of computing devices 100 in accordance with one or more techniques of this disclosure. FIG. 2 illustrates only one particular example of computing device 200, and many other examples of computing device 200 may be used in other instances and may include a subset of the components included in example computing device 200 or may include additional components not shown in FIG. 2.

As shown in FIG. 2, computing device 200 may include one or more user interface devices 202 (“UI device 202”), one or more processors 224 (“processor 224”), one or more storage devices 232 (“storage device 232”), one or more communication units 226 (“communication unit 226”). As also shown in FIG. 2, UI device 202 may include one or more input devices 228 (“input device 228”) and one or more output devices 230 (“output device 230”). As also shown in FIG. 2, storage device 232 may include a user interface module 204 (“UI module 204”), one or more application modules 206 (“application module 206”), an image module 208 that includes ML model 212, an operating system 234 (“OS 234”), and a database 236.

In some examples, UI device 202 may be a presence-sensitive display configured to detect input (e.g., touch and non-touch input) from a user of respective computing device 200. UI device 202 may output information to a user in the form of a UI, which may be associated with functionality provided by computing device 200. Such UIs may be associated with computing platforms, operating systems, applications, and/or services executing at or accessible from computing device 200 (e.g., electronic message applications, chat applications, Internet browser applications, mobile or desktop operating systems, social media applications, electronic games, menus, and other types of applications).

Processor 224 may implement functionality and/or execute instructions within computing device 200. For example, processor 224 may receive and execute instructions that provide the functionality of modules 204-208 and OS 234. These instructions executed by processor 224 may cause computing device 200 to store and/or modify information within storage device 232 during program execution. Processor 224 may execute instructions of modules 204-208 and OS 234 to perform one or more operations. That is, modules 204-208 and OS 234 may be operable by processor 224 to perform various functions described herein.

Storage device 232 of computing device 200 may store information for processing during operation of computing device 200 (e.g., computing device 200 may store data accessed by modules 204-208 and OS 234 during execution at computing device 200). In some examples, storage device 232 may be a temporary memory, meaning that a primary purpose of storage device 232 is not long-term storage. Storage device 232 of computing device 200 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage device 232 may include one or more computer-readable storage media. Storage device 232 may be configured to store larger amounts of information than volatile memory. Storage device 232 may further be configured for long-term storage of information as non-volatile memory space and retain information after power on/off cycles. Examples of non-volatile memories include magnetic hard disks, optical discs, floppy discs, flash memories, or forms of electrically programmable memories (EPROM) or electrically erasable and programmable (EEPROM) memories. Storage device 232 may store program instructions and/or information (e.g., within database 236) associated with modules 204-208 and OS 234.

Communication unit 226 of computing device 200 may communicate with one or more external devices via one or more wired and/or wireless networks by transmitting and/or receiving network signals on the one or more networks. Examples of communication units 226 include a network interface card (e.g., an Ethernet card), an optical transceiver, a radio frequency transceiver, a GPS receiver, or any other type of device that can send and/or receive information. Other examples of communication unit 226 may include short wave radios, cellular data radios, satellite data radios, wireless network radios, as well as universal serial bus (USB) controllers.

Input device 228 of computing device 200 may receive input. Examples of input are tactile, audio, and video input. Input device 228 of computing device 200, in one example, includes a presence-sensitive display, a fingerprint sensor, touch-sensitive screen, mouse, keyboard, voice responsive system, video camera, microphone or any other type of device for detecting input from a human or machine.

Input devices 228 may include one or more sensors. Numerous examples of sensors exist and include any input component configured to obtain environmental information about the circumstances surrounding computing device 200 and/or physiological information that defines the activity state and/or physical well-being of a user of computing device 200. In some examples, a sensor may be an input component that obtains physical position, movement, and/or location information of computing device 200. For instance, sensors may include one or more location sensors (e.g., GNSS components, Wi-Fi components, cellular components), one or more temperature sensors, one or more motion sensors (e.g., multi-axial accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

Output device 230 of computing device 200 may generate one or more outputs. Examples of outputs are tactile, audio, and video output. Output device 230 of computing device 200, in one example, includes a presence-sensitive display, sound card, video graphics adapter card, speaker, liquid crystal display (LCD), or any other type of device for generating output to a human or machine.

Communication channels 238 (“COMM channel 238”) may interconnect each of the components 202, 224, 226, and 228 for inter-component communications (physically, communicatively, and/or operatively). In some examples, communication channel 238 may include a system bus, a network connection, an inter-process communication data structure, or any other method for communicating data.

Computing device 200 may include OS 234. OS 234 may control the operation of components of computing device 200. For example, OS 234 may facilitate the communication of modules 204-208 with UI devices 202, processors 224, storage devices 232, and communication units 226. In some examples, OS 234 may manage interactions between software applications (e.g., application module 206A) and a user of computing device 200. OS 234 may have a kernel that facilitates interactions with underlying hardware of computing device 200 and provides a fully formed application space capable of executing a wide variety of software applications having secure partitions in which each of the software applications executes to perform various operations. In some examples, UI module 204 may be considered a component of OS 234.

Database 236 may store data regarding images for use by a user of computing device 200. Database 236 may store images such as emoticons, emojis, and other images for use by a user of computing device 200. Database 236 may store images for selection by a user of computing device 200 and use in creation of a modified image.

In the example of FIG. 2, image module 208 may include a hardware device having various hardware, firmware, and software components. However, FIG. 2 illustrates only one particular example of image module 208, and many other examples of image module 208 may be used in accordance with techniques of this disclosure. In some examples, components of image module 208 may be located in a singular location. In other examples, one or more components of image module 208 may be in different locations (e.g., connected via the network of FIG. 1A). That is, in some examples image module 208 may be part of a conventional computing device, while in other examples, image module 208 may be part of a distributed or “cloud” computing system such as cloud computing platform 110 as illustrated in FIG. 1A and FIG. 1B. In such examples, computing device 200 may send and receive messages, data, or otherwise exchange information with the remote computing system such that the remote computing system provides computing device 200 with the functionality of image module 208. In some examples, image module 208 may be functionally split between computing device 200 and one or more remote computing systems such that a portion of the functionality provided by image module 208 is performed locally at computing device 200 and other portions of the functionality are performed by the one or more remote computing systems.

Image module 208 may provide a request to create an image, via communication unit(s) 226, to an external computing device in response to a user request to create the image. Image module 208 may provide data regarding an image generation request that includes a selection of one or more images and an image generation prompt. For example, image module 208 may provide an image generation request that includes a selection of two emoticons such as images 120 in addition to text within text field 114 as illustrated in FIG. 1A to an external computing device.

FIG. 3 is a block diagram illustrating a cloud computing platform 300. Cloud computing platform 300 may be one example of cloud computing platform 110 in accordance with one or more techniques of this disclosure. FIG. 3 illustrates only one particular example of cloud computing platform 300, and many other examples of cloud computing platform 300 may be used in other instances and may include a subset of the components included in example cloud computing platform 300 or may include additional components not shown in FIG. 3.

As shown in FIG. 3, cloud computing platform 300 includes one or more user interface device(s) 302 (“UI devices 302”), one or more processors(s) 324, communication unit(s) 326, database(s) 328, and communication channels 350 (“COMM. Channel(s) 350”). As also shown in FIG. 3, database(s) 328 may include text encoder 306, images 308, and ML 312.

In some examples, UI devices 302 may be a presence-sensitive display configured to detect input (e.g., touch and non-touch input) from a user of cloud computing platform 300. UI devices 302 may output information to a user in the form of a UI, which may be associated with functionality provided by cloud computing platform 300. Such UIs may be associated with computing platforms, operating systems, applications, and/or services executing at or accessible from cloud computing platform 300 (e.g., electronic message applications, chat applications, Internet browser applications, mobile or desktop operating systems, social media applications, electronic games, menus, and other types of applications).

Input device(s) 334 of cloud computing platform 300 may receive input. Examples of input are tactile, audio, and video input. Input device(s) 334 of cloud computing platform 300, in one example, includes a presence-sensitive display, a fingerprint sensor, touch-sensitive screen, mouse, keyboard, voice responsive system, video camera, microphone or any other type of device for detecting input from a human or machine.

Input device(s) 334 may include one or more sensors. Numerous examples of sensors exist and include any input component configured to obtain environmental information about the circumstances surrounding cloud computing platform 300 and/or physiological information that defines the activity state and/or physical well-being of a user of cloud computing platform 300. In some examples, a sensor may be an input component that obtains physical position, movement, and/or location information of cloud computing platform 300. For instance, sensors may include one or more location sensors (e.g., GNSS components, Wi-Fi components, cellular components), one or more temperature sensors, one or more motion sensors (e.g., multi-axial accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

Output device(s) 336 of cloud computing platform 300 may generate one or more outputs. Examples of outputs are tactile, audio, and video output. Output device(s) 336 of cloud computing platform 300, in one example, includes a presence-sensitive display, sound card, video graphics adapter card, speaker, liquid crystal display (LCD), or any other type of device for generating output to a human or machine.

Processor(s) 324 may implement functionality and/or execute instructions within cloud computing platform 300. For example, processor(s) 324 may receive and execute instructions that provide the functionality text encoder 306, images 308, and ML model 312. These instructions executed by processor(s) 324 may cause cloud computing platform 300 to store and/or modify information within database(s) 328 during program execution. Processor(s) 324 may execute instructions of text encoder 306, images 308, and ML model 312 to perform one or more operations. That is, text encoder 306, images 308, and ML model 312 may be operable by processor(s) 324 to perform various functions described herein.

Communication unit(s) 326 of cloud computing platform 300 may communicate with one or more external devices via one or more wired and/or wireless networks by transmitting and/or receiving network signals on the one or more networks. Examples of communication unit(s) 326 include a network interface card (e.g., an Ethernet card), an optical transceiver, a radio frequency transceiver, a GPS receiver, or any other type of device that can send and/or receive information. Other examples of communication unit(s) 326 may include short wave radios, cellular data radios, satellite data radios, wireless network radios, as well as universal serial bus (USB) controllers.

Communication channels 350 (“COMM channel(s) 350”) may interconnect each of the components 302, 324, 326, and 328 for inter-component communications (physically, communicatively, and/or operatively). In some examples, communication channels 350 may include a system bus, a network connection, an inter-process communication data structure, or any other method for communicating data.

Database(s) 328 may include one or more databases for storing data. Database(s) 328 may be composed of one or more types of storage such as hard disk drives, solid state drives, tape drives, virtualized network storage, and other types of data storage. Database(s) 328 include text encoder 306. Text encoder 306 may process text received from a user such as an image generation prompt and convert the text into one or more commands or data otherwise understandable by ML model 312. Text encoder 306 may process the text received from a user that includes one or more requirements for an image to be generated by ML model 312.

Database(s) 328 may store data regarding images for use by cloud computing platform 300. Database(s) 328 may store images such as emoticons, emojis, and other images in images 308 for use by cloud computing platform 300. Images 308 may store images for selection by cloud computing platform 300 and for use in creating a modified image.

Cloud computing platform 300 may receive user requests from a computing device (e.g., computing device 200 as illustrated by FIG. 2). Cloud computing platform 300 may receive requests to generate one or more images that are a combination of multiple images or the modification of text in accordance with a stylized typography.

Cloud computing platform 300 may apply a machine learning model, such as ML model 312, to generate suggested messages relevant to a message thread. In some examples, ML model 312 can be or include one or more artificial neural networks (also referred to simply as neural networks). A neural network can include a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

ML model 312 can be or include one or more generative neural networks. A generative neural network may include a generator that generates new data points or samples in the form of images, text, audio, etc. The generator may be trained to create realistic, synthetic data samples (e.g., images) by analyzing the underlying patterns and structures in a given training dataset. For example, the generator may transform a low-dimensional input by applying a series of layers (e.g., convolutional layers for image generation) to produce a higher-dimensional output that resembles the target data.

In some examples, the generator may learn to produce better-quality samples by participating in an adversarial training process with another neural network, such as a discriminator. This type of neural network may be referred to as a generative adversarial network (GAN). In a GAN, the aim of the generator may be to create fake samples that the discriminator determines to be real, while the aim of the discriminator may be to correctly distinguish between real and fake samples. During training, the generator may receive feedback from the discriminator in the form of gradients, which may update parameters of the generator and in turn improve output quality.

In some examples, ML model 312 may be or include an autoencoder. The aim of an autoencoder may be to learn a representation (e.g., a lower-dimensional encoding) for a set of data, typically for the purpose of dimensionality reduction. For example, in some examples, an autoencoder can seek to encode the input data and then provide output data that reconstructs the input data from the encoding. In some examples, the autoencoder can include additional losses beyond reconstructing the input data. ML model 312 may be or include one or more other forms of artificial neural networks such as, for example, deep Boltzmann machines, deep belief networks, stacked autoencoders, etc. Any of the neural networks described herein can be combined (e.g., stacked) to form more complex networks.

In some examples, ML model 312 may include one or more ML models. ML model 312 may include a first machine learning model that is a text generation model, and a second machine learning that is trained with a dataset.

In some examples, ML model 312 can be or include one or more convolutional neural networks. In some examples, a convolutional neural network can include one or more convolutional layers that perform convolutions over input data using learned filters. Filters can also be referred to as kernels. Convolutional neural networks can be especially useful for vision problems such as when the input data includes imagery such as still images or video. It should be understood that the configurations of ML model 312 discussed herein are provided as examples and that other example configurations are contemplated by this disclosure.

By leveraging ML model 312, cloud computing platform 300 may decrease the time and/or effort required to create an image worthy of sending to another user. That is, by generating images on behalf of a user of a computing device such as computing device 200, the techniques of this disclosure may reduce the likelihood that the user will need to manually edit an image, which may be deficient because of practical or other constraints.

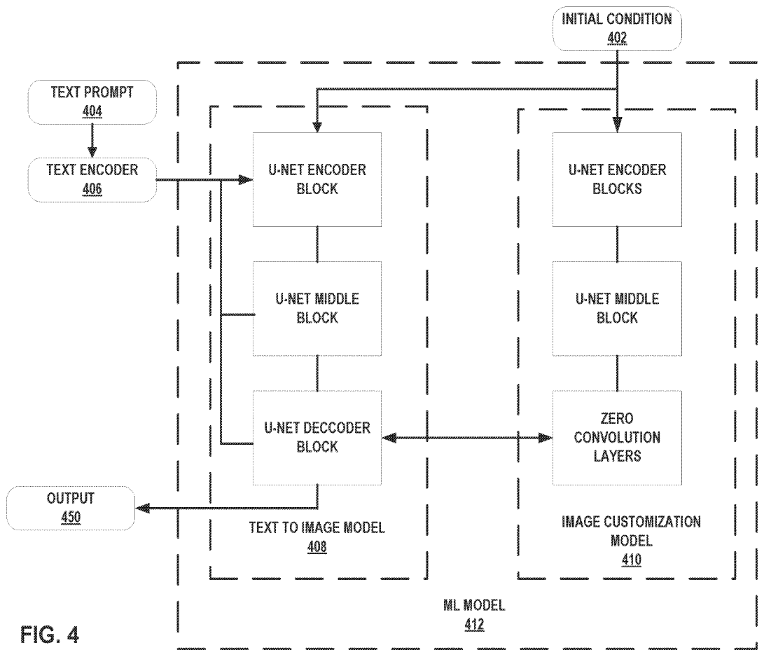

FIG. 4 is a block diagram illustrating an example of a machine learning model in accordance with techniques of this disclosure. ML model 412 may be similar if not substantially similar to ML model 312 and ML model 112.

In some examples, ML model 412 may be trained by optimizing an objective function. For example, in some examples, an objective function may be or include a loss function, such as cross-entropy loss. One or more of various optimization techniques may be performed to optimize an objective function. For example, the optimization technique(s) may minimize or maximize an objective function. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some examples, backward propagation of errors may be used in conjunction with an optimization technique (e.g., gradient based techniques) to train ML model 412 (e.g., when a machine-learned model is a multi-layer model such as an artificial neural network). For example, an iterative cycle of propagation and model parameter (e.g., weights) update may be performed to train ML model 412. Example backpropagation techniques include truncated backpropagation through time, Levenberg-Marquardt backpropagation, etc.

In some examples, ML model 412 described herein may be trained using unsupervised learning techniques to increase the effectiveness of ML model 412. Unsupervised learning may include inferring a function to describe hidden structure from unlabeled data. For example, a classification or categorization may not be included in the data. Unsupervised learning techniques may be used to produce machine-learned models capable of performing clustering, anomaly detection, learning latent variable models, or other tasks.

In some examples, ML model 412 may utilize an inversion-based technique that inverts a base image such as an image selected in accordance with text prompt 404 (e.g., a coffee cup) into an embedding space. ML model 412 may manipulate attention layers in accordance with text prompt 404 using a text-image co-embedding based model such as DALL-E 2 and Imagen. ML model 412 may fine-tune text to image model 408 to represent a base emoticon image and applies text prompt 404 as processed by text encoder 406 to text to image model 408 to generate output 450 using ML models such as Stable Diffusion, low-rank adaption of large language models (LoRA), and/or ControlNet.

ML model 412 may be trained to increase the effectiveness of ML model 412 using semi-supervised techniques which combine aspects of supervised learning and unsupervised learning. ML model 412 may be trained or otherwise generated through evolutionary techniques or genetic algorithms. In some examples, ML model 412 described herein may be trained using reinforcement learning. In reinforcement learning, an agent (e.g., model) may take actions in an environment and learn to maximize rewards and/or minimize penalties that result from such actions. Reinforcement learning may differ from the supervised learning problem in that correct input/output pairs are not presented, nor sub-optimal actions explicitly corrected.

In some examples, ML model 412 may be tuned utilizing text prompts such as initial condition 402 to bind an identifier to a specific subject. In an example, ML model 412 may bind an identifier to each subject of a plurality of subjects (e.g., cats, coffee, plane, morning, daylight, etc.). ML model 412 may perform conditioning on text stylization through generating sticker image using different image based conditions as initial condition 402, and utilize sticker assets as part of a training dataset as part of training ML model 412.

In some examples, ML model 412 described herein may include or otherwise be impacted by a number of hyperparameters, such as, for example, learning rate, number of layers, number of nodes in each layer, number of leaves in a tree, number of clusters; etc. Hyperparameters may affect model performance. Hyperparameters may be hand selected or may be automatically selected through application of techniques such as, for example, grid search; black box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some examples, various techniques may be used to optimize and/or adapt the learning rate when the model is trained. Example techniques and/or tools for performing learning rate optimization or adaptation include Adagrad; Adaptive Moment Estimation (ADAM); Adadelta; RMSprop; etc. In some examples, transfer learning techniques may be used to provide an initial model from which to begin training of ML model 412 described herein.

In some examples, ML model 412 may ensure quality standards of dynamic text sticker by ensuring that a generated image is free of typos (e.g., correcting “Good Mornnning” to “Good Morning”). In addition, ML model 412 may ensure consistent style of a generated text sticker by tuning image customization model 410 with metadata of base images (e.g., utilizing the metadata of a picture of the moon to avoid combining it with the phrase “Good Morning”). ML model 412 may retrain image customization model 410 using character-level text encoders. In addition, ML model 412 may receive an initial condition of an image as additional input, and utilize previously created images and template as training data.

In some examples, ML model 412 may utilize an LLM to generate theme-fitting elements. For example, ML model 412 may utilize the LLM to identify elements that are associated with each other (e.g., a picture of the moon associated with phrases such as “Good Evening”).

In some examples, ML model 412 described herein may be included in different portions of computer-readable code on a computing device. In one example, ML model 412 may be included in a particular application or program and used (e.g., exclusively) by such particular application or program. Thus, in one example, a computing device may include a number of applications and one or more of such applications may contain its own respective machine learning library and machine-learned model(s).

In another example, ML model 412 described herein may be included in an operating system of a computing device (e.g., in a central intelligence layer of an operating system) and may be called or otherwise used by one or more applications that interact with the operating system. In some examples, each application may communicate with the central intelligence layer (and model(s) stored therein) using an application programming interface (API) (e.g., a common, public API across all applications).

In some examples, the central intelligence layer may communicate with a central device data layer. The central device data layer may be a centralized repository of data for the computing device. The central device data layer may communicate with a number of other components of the computing device, such as, for example, one or more sensors, a context manager, a device state component, and/or additional components. In some examples, the central device data layer may communicate with each device component using an API (e.g., a private API).

In the example of FIG. 4, ML model 412 includes text to image model 408 (hereinafter “model 408”) and image customization model 410 (hereinafter “model 410”). Model 408 may be a ML model configured to convert text into one or more images such as a large language model (LLM). Text to image model 408 may be trained by a different computing device and provided to a cloud computing platform such as cloud computing platform 300 as illustrated in FIG. 3.

Image customization model 410 may be a ML model configured to modify images according to one or more parameters. Image customization model 410 may be composed of one or more machine learning models for image generation such as Stable Diffusion and/or ControlNet. Image customization model 410 may be trained by a computing platform such as cloud computing platform 300 on one or more types of data such as hand-illustrated images of stylized text. Image customization model 410 may form one or more logical layers above text to image model 408 to constitute ML model 412.

In order to train ML model 412, cloud computing platform 300 or computing device 100 as illustrated in FIG. 1A may provide ML model 412 with initial condition 402. As one example, cloud computing platform 300 may provide ML model 412 with an initial condition of the words “good morning”. Initial condition 402 does not align with the sought output of ML model 412, in the case of FIG. 4, an image of a coffee cup with the words “good morning” stylized and located visually adjacent to the coffee cup. ML model 412 may be trained to obtain the initial condition and generate the desired output, i.e., output 450.

Cloud computing platform 300 and/or computing device 100 may further provide text prompt 404 to ML model 412 to indicate the desired output. Continuing the example above, text prompt 404 may include the phrase “A word art of ‘good morning’ with coffee in the background” to indicate the desired image for ML model 412 to output. Text encoder 406 may process text prompt 404 into a series of commands or data otherwise understandable by text to image model 408.

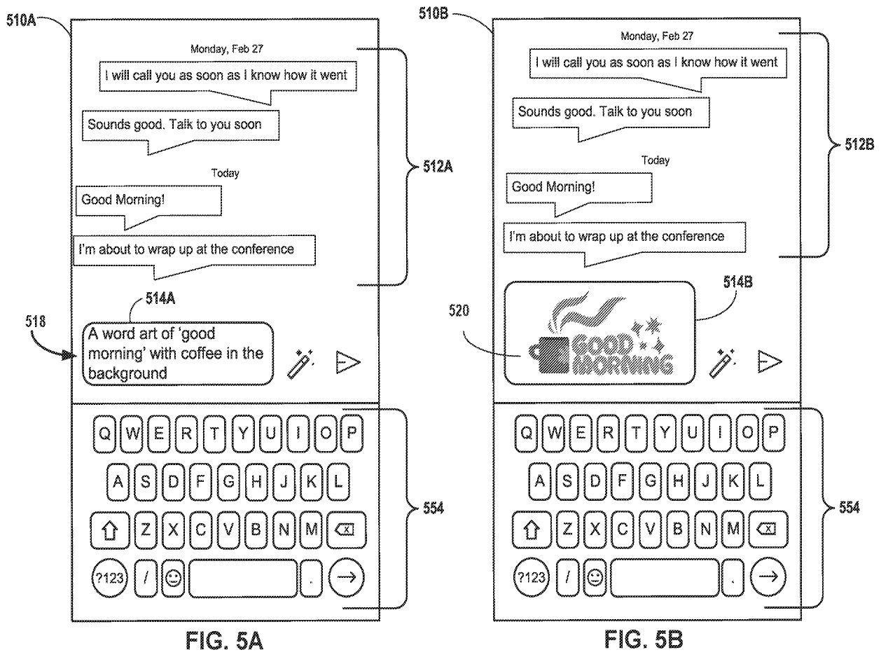

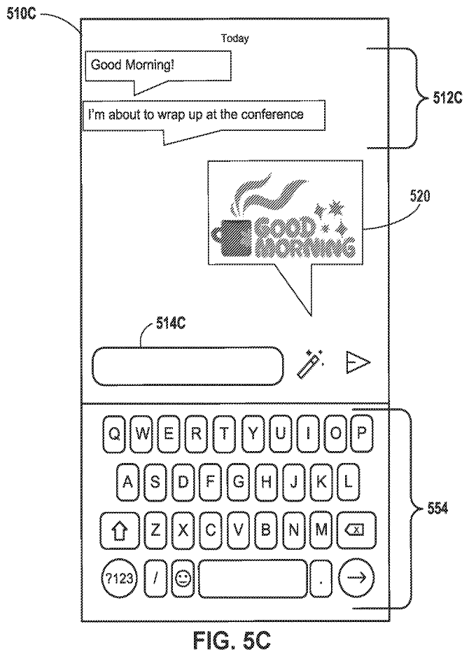

FIGS. 5A-5C are conceptual diagrams illustrating example GUIs for providing images modified by a ML model in accordance with the techniques of this disclosure. Although the operation of FIG. 5 is described as being performed by computing device 100 of FIGS. 1A-1B, in other examples some or all of the example operation may be performed by another computing device.

As described above, ML model 112 may generate image 520 based on text prompt 518 entered into text field 514A of GUI 510A. For example, a user may enter text into text field 514A to describe a combination of stylized text and one or more images that they would like to have generated and sent to another user.

In the example of FIG. 5A, a user is messaging another user as part of a conversation 512A. Conversation 512A may be a text message conversation, electronic message conversation, or one or more types of text-based messaging between one or more users.

In the example of FIG. 5A, a user has entered text prompt 518 that includes “A word art of ‘good morning’ with coffee in the background” into text field 514A. Responsive to the request to generate an image, computing device 100 may provide text prompt 518 to cloud computing platform 110 for ML model 112 to generate an image, or computing device 100 may provide text prompt 518 to ML model 112 on computing device 100 to generate an image, without using cloud computing platform 110. Computing device 100 may enable a user to request the generation of an image through a text field such as the text field in a text messaging application. Computing device 100 may provide a user with a visual element within GUI 510A to indicate that they wish to create an image and send it as part of a conversation such as conversation 512A. Computing device 100 may enable a user to utilize graphical keyboard 554 to type text prompt 518 in text field 514A.

In the example of FIG. 5B, computing device 100 has received image 520 from cloud computing platform 110 and displayed for image 520 user to review in graphical user interface 510B. Computing device 100 may display image 520 in text field 514B for a user to review before sending to another user as part of conversation 512B to ensure that image 520 meets the user's standards for image quality and creativity.

In the example of FIG. 5C, computing device 100 has sent image 520 to another user who is a member of conversation 512C. Computing device 100 may update GUI 510C to hide older messages of conversation 512C and provide visual space to display image 520 that has been sent as a message. Computing device 100 may additionally modify the visual scale of text box 514C as there is no longer a text prompt or image within text box 514C.

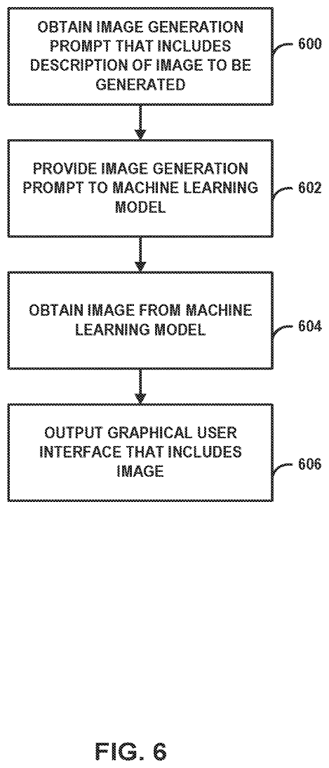

FIG. 6 is a flow diagram illustrating an example operation for generating images in accordance with one or more techniques of this disclosure.

In the example of FIG. 6, a computing device such as computing device 100 as illustrated in FIGS. 1A-1B obtains an image generation prompt that includes a description of the image to be generated (600). Computing device 100 may obtain an image generation prompt that includes a selection of an image such as an emoticon, a selection of text to be incorporated into the image, one or more descriptions of the requested image (e.g., place a coffee cup behind the text), and other elements.

Computing device 100 provides the image generation prompt to a machine learning model such as ML model 112 as illustrated in FIGS. 1A-1B (602). Computing device 100 may provide the image generation prompt and a selected image to ML model 112 for ML model 112 to generate the requested image. Computing device 100 obtains the image from ML model 112 (604).

Computing device 100 outputs a graphical user interface that includes the image (606). Computing device 100 may output a graphical user interface that includes the image in one or more contexts such as of a chain of messages in a messaging application.

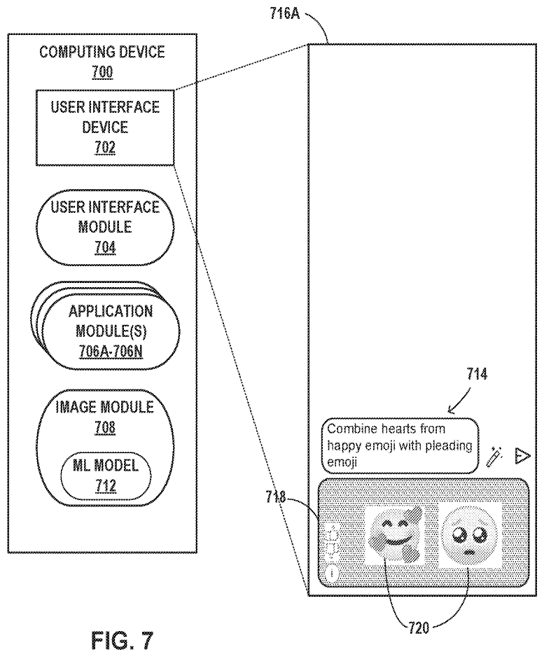

FIG. 7 is a conceptual diagram illustrating an example computing environment and graphical user interfaces for providing images generated in response to a user prompt in accordance with one or more techniques of this disclosure.

FIG. 7 is a conceptual diagram illustrating an example computing device 700 and graphical user interface 716A (“GUI 716A”) for generating images according to user prompts in accordance with one or more techniques of this disclosure.

As shown in the example of FIG. 7, computing device 700 may be substantially similar to computing device 100. Computing device 700 includes user interface device 702, user interface module 704, application module(s) 706A-706N, and image module 708. In the example of FIG. 7, GUI 716A includes text field 714, area 718, and images 720.

In some examples, GUI 716A may include area 718 for drawing. The user may provide an input that draws at least a portion of image 720 within area 718. Additionally, UI module 704 may output, for display by UI device 702, image 720 in area 718, thereby enabling the user to see (e.g., in real-time) the effect of the input on image 720. The user may draw the entirety of images 720 using area 718. Alternatively, the user may select a pre-existing image, causing GUI 716A to include the pre-existing image in area 718. The user may then draw a set of elements in relation to the pre-existing image. The relationship between the set of elements and the pre-existing image may be at least based on the position of the set of elements relative to the position of the pre-existing image.

In some examples, GUI 716A may include text field 714 for a user to provide a text prompt for generating the desired image. In an example, text field 714 may include a user-provided text description of the image that they would like to create in addition to images 720. In another example, text field 714 may include a user prompt such as “combine hearts from happy emoji with pleading emoji” or “word art of ‘good morning’ with coffee in the background”. Computing device 700 may cause the generation of an image using a combination of a user prompt in text field 714 and images 720 in area 718 or may cause generation of an image only using a text prompt within text field 714.

In the example of FIG. 7, image module 708 may include a hardware device having various hardware, firmware, and software components. However, FIG. 7 illustrates only one particular example of image module 708, and many other examples of image module 708 may be used in accordance with techniques of this disclosure. In some examples, components of image module 708 may be located in a singular location. In other examples, one or more components of image module 708 may be in different locations (e.g., connected via the network of FIG. 1). That is, in some examples image module 708 may be part of a conventional computing device, while in other examples, image module 708 may be part of a distributed or “cloud” computing system as illustrated in FIG. 1A. Further, image module 708 may be located in and executed by a computing system remote from and communicatively coupled to computing device 700. In such examples, computing device 700 may send and receive messages, data, or otherwise exchange information with the remote computing system such that the remote computing system provides computing device 700 with the functionality of image module 708. In some examples, image module 708 may be functionally split between computing device 700 and one or more remote computing systems such that a portion of the functionality provided by image module 708 is performed locally at computing device 700 and other portions of the functionality are performed by the one or more remote computing systems.

Image module 708 includes ML model 712. ML model 712 may be similar or substantially similar to ML model 112 as executed by cloud computing platform 110 as illustrated in FIG. 1A. ML model 712 may generate a modified image (e.g., modified image 122 as illustrated in FIG. 1B). ML model 712 may produce one or more unique images (e.g., different variations), apply an artistic style (e.g., cubism, impressionism, minimalism, contemporary, abstract, baroque, etc.), etc. ML model 712 may generate an emoji kitchen (EK) by combining two or more emoji images that preserve the details of each emoji and/or combine a single emoticon with an add-on element (e.g., tears, sweat, heart, etc.). In addition, ML model 712 may produce an image that is inspired by the style of emoticons, but is in a different format (e.g., a ghost dog emoji rendered in 3 dimensions). Further, ML model 712 may generate customized text stickers based on a user's textual input in accordance with a typography determined from the textual input and background content (e.g., semantics/emotions of the textual input). ML model 712 may generate customized text stickers in accordance with a typography based on a user selection of a background image. In addition, ML model 712 may generate an image according to an image-based condition, where the image-based condition is an image of the text for a message in one or more selected fonts.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Example 1: A method includes obtaining, by a computing device, an image generation prompt that includes a description of an image to be generated; providing, by the computing device, the image generation prompt to a machine learning model; obtaining, by the computing device, the image from the machine learning model; and outputting, by the computing device, a graphical user interface that includes the image.

Example 2: The method of example 1, further comprising obtaining, by the computing device, a selection of an emoticon, wherein providing the image generation prompt to the machine learning model comprises providing the selection of the emoticon to the machine learning model, and wherein the image obtained from the machine learning model is a modification of the emoticon according to the image generation prompt.

Example 3: The method of example 2, wherein the emoticon is a first emoticon, the method further comprising obtaining, by the computing device, a selection of a second emoticon, wherein the image generation prompt includes a description of a combination of the first emoticon and the second emoticon, and wherein the image obtained from the machine learning model is a combination of the first emoticon and the second emoticon according to the image generation prompt.

Example 4: The method of example 3, wherein the description of the combination of the first emoticon and the second emoticon comprises a selection of one or more elements of the first emoticon to be added to the second emoticon.

Example 5: The method of example 2, wherein the image is in a style different from that of the emoticon.

Example 6: The method of any of examples 1 through 5, wherein the image generation prompt includes text for a message and one or more styles of typography, wherein the image obtained from the machine learning model is a text sticker, and wherein the text sticker is an image of the text styled according to the one or more styles of typography.

Example 7: The method of any of examples 1 through 6, wherein the one or more styles of typography are based on a user selection of a background image.

Example 8: The method of any of examples 1 through 7, wherein the one or more styles of typography are based on background content that corresponds to semantics of the text for a message.

Example 9: The method of any of examples 1 through 8, wherein the image is generated according to an image-based condition, wherein the image-based condition is an image of the text for a message in one of one or more selected fonts.

Example 10: The method of any of examples 1 through 9, further comprising causing, by the computing device, the machine learning model to bind an identifier to a subject of the image.

Example 11: The method of any of examples 1-10, wherein the machine learning model comprises a first machine learning model and a second machine learning model, wherein the first machine learning model is text generation model, and wherein the second machine learning model is an image customization model.

Example 12: A computing device includes a memory; and one or more programmable processors in communication with the memory, and configured to obtain an image generation prompt that includes a description of an image to be generated; provide the image generation prompt to a machine learning model; obtain the image from the machine learning model; and output a graphical user interface that includes the image.

Example 13: The computing device of example 12, wherein the one or more programmable processors are further configured to obtain a selection of a first emoticon, wherein provide the image generation prompt to the machine learning model comprises provide the selection of the first emoticon to the machine learning model, and wherein the image obtained from the machine learning model is a modification of the first emoticon according to the image generation prompt.

Example 14: The computing device of example 13, wherein the one or more programmable processors are configured to obtain a selection of a second emoticon, wherein the image generation prompt includes a description of a combination of the first emoticon and the second emoticon, and wherein the image obtained from the machine learning model is a combination of the first emoticon and the second emoticon according to the image generation prompt.

Example 15: The computing device of example 14, wherein the description of the combination of the first emoticon and the second emoticon comprises a selection of one or more elements of the first emoticon to be added to the second emoticon.

Example 16: The computing device of example 13, wherein the image is in a style different from that of the emoticon.

Example 17: The computing device of any of examples 12 through 16, wherein the image generation prompt includes text for a message and one or more styles of typography, and wherein the image obtained from the machine learning model is a text sticker, wherein the text sticker is an image of the text styled according to the one or more styles of typography.

Example 18: The computing device of any of examples 12 through 17, wherein the one or more styles of typography are based on a user selection of a background image.

Example 19: The computing device of any of examples 12 through 18, wherein the one or more styles of typography are based on background content that corresponds to semantics of the text for a message.

Example 20: The computing device of any of examples 12 through 19, wherein the image is generated according to an image-based condition, wherein the image-based condition is an image of the text for a message in one of one or more selected fonts.

Example 21: The computing device of any of examples 12 through 20, wherein the one or more programmable processors are further configured to cause the machine learning model to bind an identifier to a subject of the image.

Example 22: The computing device of any of examples 12 through 21, wherein the machine learning model comprises a first machine learning model, wherein the first machine learning model is text generation model, and a second machine learning model, wherein the second machine learning model is an image customization model.

Example 23: A non-transitory computer-readable medium, encoded with instructions that, when executed by one or more processors, cause the one or more processors to: obtain an image generation prompt that includes a description of an image to be generated; provide the image generation prompt to a machine learning model; obtain the image from the machine learning model; and output a graphical user interface that includes the image.

Example 24: The non-transitory computer-readable medium of example 23, wherein the instructions further cause the one or more processors to obtain a selection of a first emoticon, wherein provide the image generation prompt to the machine learning model comprises provide the selection of the first emoticon to the machine learning model, and wherein the image obtained from the machine learning model is a modification of the first emoticon according to the image generation prompt.

Example 25: The non-transitory computer-readable medium of example 24, wherein the instructions further cause the one or more processors to obtain a selection of a second emoticon, wherein the image generation prompt includes a description of a combination of the first emoticon and the second emoticon, and wherein the image obtained from the machine learning model is a combination of the first emoticon and the second emoticon according to the image generation prompt.

Example 26: The non-transitory computer-readable medium of example 25, wherein the description of the combination of the first emoticon and the second emoticon comprises a selection of one or more elements of the first emoticon to be added to the second emoticon.

Example 27: The non-transitory computer-readable medium of example 24, wherein the image is in a style different from that of the emoticon.

Example 28: The non-transitory computer-readable medium of any of examples 23 through 27, wherein the image generation prompt includes text for a message and one or more styles of typography, and wherein the image obtained from the machine learning model is a text sticker, wherein the text sticker is an image of the text styled according to the one or more styles of typography.

Example 29: The non-transitory computer-readable medium of any of examples 23 through 28, wherein the one or more styles of typography are based on a user selection of a background image.

Example 30: The non-transitory computer-readable medium of any of examples 23 through 29, wherein the one or more styles of typography are based on background content that corresponds to semantics of the text for a message.

Example 31: The non-transitory computer-readable medium of any of examples 23 through 30, wherein the image is generated according to an image-based condition, wherein the image-based condition is an image of the text for a message in one of one or more selected fonts.

Example 32: The non-transitory computer-readable medium of any of examples 23 through 31, wherein the instructions are further configured to cause the one or more processors to cause the machine learning model to bind an identifier to a subject of the image.

Example 33: The non-transitory computer-readable medium of any of examples 23 through 32, wherein the machine learning model comprises a first machine learning model, wherein the first machine learning model is text generation model, and a second machine learning model, wherein the second machine learning model is an image customization model.

Various examples have been described. These and other examples are within the scope of the following claims.

1. A method, comprising:
obtaining, by a computing device, an image generation prompt that includes a description of an image to be generated;
providing, by the computing device, the image generation prompt to a machine learning model;
obtaining, by the computing device, the image from the machine learning model; and
outputting, by the computing device, a graphical user interface that includes the image.

2. The method of claim 1, further comprising:
obtaining, by the computing device, a selection of an emoticon,
wherein providing the image generation prompt to the machine learning model comprises providing the selection of the emoticon to the machine learning model, and
wherein the image obtained from the machine learning model is a modification of the emoticon according to the image generation prompt.

3. The method of claim 2, wherein the emoticon is a first emoticon, the method further comprising:
obtaining, by the computing device, a selection of a second emoticon,
wherein the image generation prompt includes a description of a combination of the first emoticon and the second emoticon, and
wherein the image obtained from the machine learning model is a combination of the first emoticon and the second emoticon according to the image generation prompt.

4. The method of claim 3, wherein the description of the combination of the first emoticon and the second emoticon comprises a selection of one or more elements of the first emoticon to be added to the second emoticon.

5. The method of claim 2, wherein the image is in a style different from that of the emoticon.

6. The method of claim 1,
wherein the image generation prompt includes text for a message and one or more styles of typography,
wherein the image obtained from the machine learning model is a text sticker, and
wherein the text sticker is an image of the text styled according to the one or more styles of typography.

7. The method of claim 1, wherein the one or more styles of typography are based on a user selection of a background image.

8. The method of claim 1, wherein the one or more styles of typography are based on background content that corresponds to semantics of the text for a message.

9. The method of claim 1, wherein the image is generated according to an image-based condition, wherein the image-based condition is an image of the text for a message in one of one or more selected fonts.

10. The method of claim 1, further comprising causing, by the computing device, the machine learning model to bind an identifier to a subject of the image.

11. The method of claim 1, wherein the machine learning model comprises a first machine learning model and a second machine learning model, wherein the first machine learning model is text generation model, and wherein the second machine learning model is an image customization model.

12. A computing device, comprising:
a memory; and
one or more programmable processors in communication with the memory, and configured to:
obtain an image generation prompt that includes a description of an image to be generated;
provide the image generation prompt to a machine learning model;
obtain the image from the machine learning model; and
output a graphical user interface that includes the image.

13. The computing device of claim 12, wherein the one or more programmable processors are further configured to obtain a selection of a first emoticon,
wherein provide the image generation prompt to the machine learning model comprises provide the selection of the first emoticon to the machine learning model, and
wherein the image obtained from the machine learning model is a modification of the first emoticon according to the image generation prompt.

14. The computing device of claim 13, wherein the emoticon is a first emoticon and wherein the one or more programmable processors are further configured to obtain a selection of a second emoticon,
wherein the image generation prompt includes a description of a combination of the first emoticon and the second emoticon, and
wherein the image obtained from the machine learning model is a combination of the first emoticon and the second emoticon according to the image generation prompt.

15. A non-transitory computer-readable medium, encoded with instructions that cause one or more processors of a computing system to:
obtain an image generation prompt that includes a description of an image to be generated;
provide the image generation prompt to a machine learning model;
obtain the image from the machine learning model; and
output a graphical user interface that includes the image.

16. The non-transitory computer-readable medium of claim 15, wherein the instructions further cause the one or more processors to obtain a selection of an emoticon,
wherein providing the image generation prompt to the machine learning model comprises providing the selection of the emoticon to the machine learning model, and
wherein the image obtained from the machine learning model is a modification of the emoticon according to the image generation prompt.

17. The non-transitory computer-readable medium of claim 16, wherein the emoticon is a first emoticon and wherein the instructions further cause the one or more processors to obtain a selection of a second emoticon,
wherein the image generation prompt includes a description of a combination of the first emoticon and the second emoticon, and
wherein the image obtained from the machine learning model is a combination of the first emoticon and the second emoticon according to the image generation prompt.

18. The non-transitory computer-readable medium of claim 17, wherein the description of the combination of the first emoticon and the second emoticon comprises a selection of one or more elements of the first emoticon to be added to the second emoticon.

19. The non-transitory computer-readable medium of claim 15,
wherein the image generation prompt includes text for a message and one or more styles of typography,
wherein the image obtained from the machine learning model is a text sticker, and
wherein the text sticker is an image of the text styled according to the one or more styles of typography.

20. The non-transitory computer-readable medium of claim 15, wherein the machine learning model comprises a first machine learning model and a second machine learning model, wherein the first machine learning model is text generation model, and wherein the second machine learning model is an image customization model.
